(19) United States
(12) Patent Application Publication
(10) Pub. No.: US 2010/0210441 A1
(43) Pub. Date: Aug. 19, 2010

(54) Apparatus And Method For Separating Discrete Volumes Of A Composite Liquid

(75) Inventor: Victor D. DOLECEK, Englewood, CO (US)

Correspondence Address: CaridianBCT, Inc.;Mail Stop: 810 1F2, 10811 WEST COLLINS AVE, LAKEWOOD, CO, 80215, US

(73) Assignee: CARIDIANBCT, INC., Lakewood, CO (US)

(21) Appl. No.: 12/769,255

(22) Filed: Apr. 28, 2010

Related U.S. Application Data
(63) Continuation-in-part of application No. 12/546,315, filed on Aug. 24, 2009.
Application No. 12/546,315 is a division of application No. 11/954,388, filed on Dec. 12, 2007, now Pat. No. 7,674,221.
Application No. 11/954,388 is a continuation of application No. PCT/US2006/021827, filed on Jun. 5, 2006.
(60) Provisional application No. 60/693,320, filed on Jun. 22, 2005.

(51) Int. Cl. B01D 21/26

(52) U.S. Cl. 494/37; 494/56; 494/50

(57) ABSTRACT

An apparatus for separating at least two discrete volumes of a composite liquid into at least a first component and a second component comprises a centrifuge, which comprising a rotor having a rotation axis, comprising at least one separation cell, for containing a separation bag containing a isolated volume of composite liquid; a satellite cell for containing a satellite bag, and a fluid path between the separation cell and the satellite cell, the path being radially closer to the rotation axis than both the separation cell and the satellite cell and axially above both the separation cell and the satellite cell.

### CROSS REFERENCE TO RELATED APPLICATIONS

This application is a continuation-in-part of U.S. patent application Ser. No. 12/546,315 filed Aug. 24, 2009, which is a divisional of U.S. patent application Ser. No. 11/954388 filed Dec. 12, 2007, which is a continuation of International Application No. PCT/US2006/021827 filed Jun. 5, 2006 which claims the benefit of U.S. Provisional Application No. 60/693320 filed Jun. 22, 2005.

### FIELD OF THE INVENTION

The present invention relates to an apparatus and a method for separating at least two discrete volumes of a composite liquid into at least two components.

### BACKGROUND

The apparatus and a method of the invention are particularly appropriate for the separation of biological fluids comprising an aqueous component and one or more cellular components. For example, potential uses of the invention include: extracting a plasma component and a cellular component (including platelets, white blood cells, and red blood cells) from a volume of whole blood, the cellular component being subsequently filtered so as to remove platelets and white blood cells from the red blood cells; extracting a plasma component, in which a substantial amount of platelets is suspended, and a red blood cell component from a volume of whole blood, the white blood cells being subsequently removed by filtration from the platelet component and the red blood cell component; extracting a plasma component, a platelet component, and a red blood cell component from a volume of whole blood, the white blood cells being subsequently removed by filtration from the platelet component and the red blood cell component.

An apparatus for processing blood components is known from document WO 03/089027. This apparatus comprises a centrifuge adapted to cooperate with an annular separation bag connected to at least one product bag, e.g. a platelet component bag.

The centrifuge includes a rotor having a turntable for supporting the separation bag, and a central compartment for containing the product bag connected to the separation bag; and a squeezing system for squeezing the separation bag and causing the transfer of a separated component (e.g. platelets suspended in plasma) from the separation bag into the product bag.

With this apparatus, a single discrete volume of blood is processed at once.

### SUMMARY OF THE INVENTION

An object of the present invention is to design a separation apparatus that can process at once at least two discrete volumes of a composite liquid, in particular, discrete volumes that may not be the same, and with the proportions of the various components of the composite liquid that may vary from one discrete volume to another one.

According to the invention, a method for separating at least two discrete volumes of a composite liquid into at least a first component and a second component comprises enclosing in at least two separation cells mounted on a rotor at least two separation bags containing two discrete volumes of a composite liquid respectively; storing in a container included in the rotor at least two first satellite bags connected to the at least two separation bags respectively; rotating the rotor; and transferring a volume of hydraulic liquid into at least two interconnected expandable hydraulic chambers located in the at least two separation cells respectively, whereby the hydraulic liquid gets distributed under centrifugation forces in the at least two interconnected hydraulic chambers so as to substantially balance the rotor.

In particular, an embodiment is disclosed wherein each separation cell and an associated container for receiving component bags are located radially outwardly from a set of valves associated with the separation cell and its container. A set of bags, comprising a separation bag and at least one component bag connected by a tube, are mounted on the rotor. The separation bag is placed in the separation cell, while the component bag is placed in the container. The connecting tube passes through the valve and is, therefore, constrained to lie radially inwardly from both the separation bag and the component bag. Rotating the rotor creates a centrifugal field, directed outwardly from the center of rotation. In this condition, at least a portion of the connecting tube is always “higher” than both the separation bag and the component bag, that is, the connecting tube is closer to the center of rotation than both of the bags. In addition, at least a portion of the connecting tube is always “above” both the separation bag and the component bag with respect to the axis of rotation of the rotor when the rotor is stopped, that is, when the apparatus is only subject to the gravitational field of the earth. In other words, at least a portion of the connecting tube is axially above all the bags of the bag set. Any air in the set of bags will collect in the highest point in the tube, so long as the centrifugal field exists. Any air in the set of bags will collect in the point of the tube above the set of bags, when the centrifugal field does not exist and the apparatus is subject only to the earth's gravitational field. Preferably, the two points are the same. The presence of air at the high point of the tube (and/or at the point above the bag set) prevents a siphon effect from developing between the separation bag and the component bag.

Other features of the method according to the invention are as follows: transferring a volume of hydraulic liquid into the at least two interconnected hydraulic chambers comprises transferring a predetermined volume of hydraulic liquid; transferring a volume of hydraulic liquid into the at least two interconnected hydraulic chambers comprises pumping hydraulic liquid into the at least two interconnected hydraulic chambers; transferring a volume of hydraulic liquid into the at least two interconnected hydraulic chambers comprises connecting a source of hydraulic liquid to the at least two interconnected hydraulic chambers so that a rotation of the rotor causes hydraulic liquid to be transferred from the source of hydraulic liquid into the at least two interconnected hydraulic chambers; rotating the rotor comprises rotating the rotor at a sedimentation speed at which the at least first and a second components sediment in each of the separation bags.

The method further comprises: transferring a first separated component from the at least two separation bags into the at least two first satellite bags connected thereto respectively; and balancing any unbalance of the rotor caused by the transfer of the first separated component into the at least two first satellite bags. Balancing any unbalance of the rotor caused by the transfer of the first separated component into the at least two first satellite component bags comprises respectively storing the at least two first satellite bags in the container against at least two interconnected flexible pouches containing a volume of a liquid secured to a wall of the container, whereby the at least two first satellite bags press against the at least two pouches under centrifugation forces and distribute the volume of liquid in the at least two pouches so as to balance the rotor. Transferring a first separated component from the at least two separation bags into the at least two first satellite bags connected thereto respectively comprises: squeezing the at least two separation bags within the at least two separation cells so as to cause a transfer of at least one fraction of the first component into the at least two first satellite bags connected thereto; detecting a characteristic of a component at a first determined location in each separation bag; stopping transferring the at least one fraction of the first component from each separation bag into the first satellite bag connected thereto, upon detection of the characteristic of a component at the first determined location. The method further comprises changing a speed of the rotor after detecting a characteristic of a component at the first determined location in the separation bag in which such detection occurs last. The method further comprises changing a speed of the rotor after a predetermined period of time after detecting a characteristic of a component at the first determined location in one of the at least two separation bags.

The method further comprises: transferring a second separated component from the at least two separation bags into at least two second satellite bags connected thereto respectively; and balancing any unbalance of the rotor caused by the transfer of the second separated component into the at least two second satellite bags. Balancing any unbalance of the rotor caused by the transfer of the second separated component into the at least two second satellite component bags comprises respectively storing the at least two second satellite bags in the container against the at least two interconnected flexible pouches containing a volume of a liquid secured to a wall of the container, whereby the at least two second satellite bags press against the at least two pouches under centrifugation forces and distribute the volume of liquid in the at least two pouches so as to balance the rotor. Transferring a second separated component from the at least two separation bags into the at least two second satellite bags connected thereto respectively comprises: squeezing one of the at least two separation bags within one of the at least two separation cells so as to cause a transfer of the second component into the second satellite bag connected thereto; detecting a characteristic of a component at a second determined location in either the squeezed separation bag or a tube connecting the squeezed separation bag to a second satellite bag; stopping squeezing the squeezed separation bag upon detection of the characteristic of a component at the second determined location; and successively repeating the above steps with each separation bag of the at least two separation bags.

The method further comprises stopping rotating the rotor after detecting a characteristic of a component at the second determined location in the separation bag or the tube connected thereto in which such detection occurs last.

The method further comprises stopping rotating the rotor after a predetermined period of time after detecting a characteristic of a component at the second determined location in one of the at least two separation bags or the tube connected thereto.

According to the invention, an apparatus for separating at least two discrete volumes of a composite liquid into at least a first component and a second component comprises a centrifuge comprises: a rotor having a rotation axis, comprising at least two separation cells, each for containing a separation bag containing a volume of composite liquid; and a first balancing means for balancing the rotor when the respective weights of the at least two separation bags in the at least two separation cells are different, comprising: at least two expandable hydraulic chambers within the at least two separation cells respectively, and the at least two hydraulic chambers are fluidly interconnected; a source of hydraulic liquid fluidly connected to the at least two hydraulic chambers; and a liquid transferring means for transferring a volume of hydraulic liquid from the hydraulic liquid source into the at least two interconnected hydraulic chambers so as to substantially balance the rotor when two separation bags respectively contained in the at least two different separation cells have different weights.

Other features of the apparatus according to the invention are as follows: The apparatus according further comprises a control unit programmed for causing the liquid transferring means to transfer a predetermined volume of hydraulic liquid from the hydraulic liquid source into the at least two interconnected hydraulic chambers, and the predetermined volume of hydraulic liquid is selected so as to substantially balance the rotor whatever the weights of two separation bags respectively contained in the at least two different separation cells.

The liquid transferring means comprises a pumping means for pumping a volume of hydraulic fluid into the at least two interconnected hydraulic chambers.

The source of hydraulic liquid is fixed with respect to the rotor and is fluidly connected to the at least two hydraulic chambers through a rotary seal.

The liquid transferring means comprises a motor for driving the rotor in rotation and the source of hydraulic liquid is fixed with respect to the rotor, below the at least two separation cells, and is fluidly connected to the hydraulic chambers through a rotary seal, whereby a rotation of the rotor causes the volume of hydraulic liquid to be transferred from the hydraulic liquid source into the hydraulic chambers.

The first balancing means further comprises a valve fitted on a conduit between the source of hydraulic liquid and the rotary seal, for controlling a transfer into the hydraulic chambers of a predetermined volume of hydraulic liquid for balancing the rotor.

The at least two hydraulic chambers are interconnected by a circular conduit centered on the rotation axis, and the circular conduit is connected to each hydraulic chamber to an area thereof that is closer to a periphery of the rotor than to the rotation axis.

The liquid transferring means comprises a motor for driving the rotor in rotation, and the source of hydraulic liquid comprises a reservoir for hydraulic liquid that is mounted on the rotor and is so designed and fluidly connected to the at least two hydraulic chambers that a rotation of the rotor causes a transfer of hydraulic liquid from the reservoir into the at least two hydraulic chambers.

The reservoir comprises a housing defining an internal volume that is symmetrical with respect to the rotation axis and a circular inner area that is the farthest to the rotation axis, and the at least two hydraulic chambers are in fluid communication with this circular area of the reservoir.

The apparatus further comprises: a storage means included in the rotor for storing at least two satellite bags respectively connected to at least two separation bags contained in the at least two separation cells; and a component transferring means for transferring at least one separated component from each separation bag into a satellite bag connected thereto.

The component transferring means comprises a pumping means for pumping hydraulic liquid from the source of hydraulic liquid into the at least two interconnected hydraulic chambers so as to squeeze the at least two separation bags within the at least two separation cells and to cause a component separated therein to flow into a satellite bag connected to each separation bag.

The source of hydraulic liquid is fixed with respect to the rotor, below the at least two separation cells, and is fluidly connected to the at least two hydraulic chambers through a rotary seal, and the component transferring means comprises: a motor for driving the rotor in rotation; and at least one valve member associated with each separation cell for selectively allowing or blocking a flow of fluid between a separation bag and a satellite bag, whereby a rotation of the rotor causes hydraulic liquid to be transferred from the hydraulic liquid source into the at least two hydraulic chambers and to squeeze the at least two separation bags within the at least two separation cells, which causes a component separated in a separation bag to flow into a satellite bag connected thereto when the valve member for allowing or blocking a flow of fluid between the separation bag and the satellite bag is open.

The apparatus further comprises: a storage means included in the rotor for storing at least two first satellite bags respectively connected to at least two separation bags contained in the at least two separation cells; and at least one valve member associated with each separation cell for selectively allowing or blocking a flow of fluid between a separation bag and a first satellite bag, and the at least one valve member is mounted on the rotor so as to be between the associated separation cell and the storage means, with respect to the rotation axis.

The apparatus further comprises: a storage means included in the rotor for storing at least two first satellite bags respectively connected to at least two separation bags contained in the at least two separation cells; and at least one valve member associated with each separation cell for selectively allowing or blocking a flow of fluid between a separation bag and a first satellite bag, and the at least one valve member is mounted on the rotor so that the storage means is between the at least one valve member and the associated separation cell, with respect to the rotation axis.

The apparatus further comprises at least one sensor associated with each separation cell for generating information related to a characteristic of a component separated in a separation bag within the separation cell.

The at least one sensor is mounted on the rotor so as to detect a characteristic of a component in a separation bag contained in the associated separation cell.

The at least one sensor is mounted on the rotor so as to detect a characteristic of a component in a tube connected to a separation bag contained in the associated separation cell.

Each separation cell comprises a substantially closed cavity having a longitudinal axis intersecting the rotation axis of the rotor and comprises a portion closer to the rotation axis of the rotor that is defined by four walls converging towards the longitudinal axis of the cavity.

The longitudinal axis of the cavity of each separation cell intersects the rotation axis of the rotor at an acute angle.

Each separation cell comprises a cavity having a bottom wall, an upper wall and a lower wall, and the hydraulic chamber is underneath a membrane that is lining at least part of either the upper wall or the lower wall of the cavity.

Each separation cell comprises a cavity having a bottom wall, an upper wall, and a lower wall, and the hydraulic chamber comprising a flexible pouch that rests at least on part the lower wall.

The density of the hydraulic liquid is so selected as to be higher than the density of the component having the highest density.

Each separation cell comprises a cavity having a bottom wall, an upper wall, and lower wall, and the hydraulic chamber is defined by an elastic socket that is secured to the separation cell so as to extend between the upper wall and the lower wall.

The density of the hydraulic liquid is so selected as to be between the density of a first component and the density of a second component.

Each separation cell comprises a securing means for securing an upper edge of a separation bag so that the upper edge is the portion of the separation bag that is the closest to the rotation axis.

The apparatus further comprises: at least one sensor associated with each separation cell for generating information related to a characteristic of a component separated in a separation bag within the separation cell; a memory unit for storing at least one change in rotation speed of the rotor; and a control unit programmed: for receiving from the memory the at least one change in rotation speed, and information generated by the at least one sensor associated with each separation cell; and for causing the at least one change in rotation speed in view of information generated by one of the at least one sensor associated with each of the at least two separation cells.

The control unit is programmed for causing the at least one change of rotation speed in view of information generated by the first of the at least one sensor associated with the at least two separation cells that detects a characteristic of a component separated in a separation bag within a separation cell.

The control unit is programmed for causing the at least one change of rotation speed in view of information generated by the last of the at least one sensor associated with the at least two separation cells that detects a characteristic of a component separated in a separation bag within a separation cell.

The apparatus further comprises at least one valve member associated with each separation cell for selectively allowing or blocking a flow of fluid between a separation bag within the separation cell and a satellite bag connected thereto, and the control unit is further programmed for causing at least once in a separation process the at least one valve member associated with a separation cell to block a flow of fluid between a separation bag within the separation cell and a satellite bag connected thereto following a detection of the characteristic of a separated component by the at least one sensor associated with the same separation cell.

The apparatus further comprises at least one valve member associated with each separation cell for selectively allowing or blocking a flow of fluid between a separation bag within the separation cell and a satellite bag connected thereto, and the control unit is further programmed for causing at least once in a separation process the at least one valve member associated with a separation cell to allow a flow of fluid between a separation bag within the separation cell and a satellite bag connected thereto following a detection of the characteristic of a separated component by the at least one sensor associated with another separation cell.

The apparatus further comprises at least one valve member associated with each separation cell for selectively allowing or blocking a flow of fluid between a separation bag within the separation cell and a satellite bag connected thereto, and the control unit is further programmed for: causing the rotor to rotate at a sedimentation speed for separating a least two components in at least two separation bags contained in the at least two separation cell respectively; causing the least one valve member associated with each separation cell to allow a flow of fluid between each separation bag and the satellite bag connected thereto; causing the component transferring means to transfer at least a portion of a separated component from each of the at least two separation bags into the satellite bag connected thereto; causing the least one valve member associated with each separation cell to block a flow of fluid between the separation bag within the separation cell and the satellite bag connected thereto, when the sensor associated with the separation cell detects the characteristic of a separated component.

The control unit is further programmed for: causing the component transferring means to stop transferring a separated component from the at least two separation bags into the satellite bags connected thereto when one sensor associated with one of the at least two the separation cells detects the characteristic of a separated component; causing the component transferring means to transfer a separated component from the at least two separation bags into the satellite bags connected thereto, after the valve member associated with the separation cell associated with the sensor that has detected the characteristic of a separated component has blocked a flow of fluid between the separation bag and the satellite bag connected thereto.

The at least one sensor comprises a first sensor for detecting a characteristic of a separated component in a separation bag within a separation cell; the least one valve member comprises a first valve member for allowing or blocking a flow of fluid between a separation bag and a first satellite bag connected thereto; the control unit is further programmed for controlling an actuation of the first valve member in view of information from the first sensor.

The at least one sensor comprises a second sensor for detecting a characteristic of a separated component in a tube connecting a separation bag to a second satellite bag; the least one valve member comprises a second valve member for allowing or blocking a flow of fluid between a separation bag and a second satellite bag connected thereto; the control unit is further programmed for controlling an actuation of a second valve member in view of information from the second sensor.

Other features and advantages of the invention will appear from the following description and accompanying drawings, which are to be considered exemplary only.

### BRIEF DESCRIPTION OF THE DRAWINGS

In the accompanying drawings:

FIG. 1 is a schematic view of a first set of bags designed for cooperating with a separation apparatus;

FIG. 2 is a schematic view of a second set of bags designed for cooperating with a separation apparatus;

FIGS. 3a, 3b are schematic views of two variants of a detail of the set of bags of FIG. 2;

FIG. 4 is a schematic view, partly in cross-section along a diametric plane, of a first embodiment of a separation apparatus;

FIG. 5 is a top view of the rotor of the separation apparatus of FIG. 4;

FIG. 6 is a perspective view of a first embodiment of a passive balancing unit for a separation apparatus;

FIG. 7 is a perspective view of a second embodiment of a passive balancing unit for a separation apparatus;

FIG. 8 is schematic view, in cross-section along a radial plane, of a separation cell of the separation apparatus of FIGS. 4 and 5;

FIG. 9 is schematic view, in cross-section along a radial plane, of an embodiment of a separation cell adjacent to a storage container;

FIG. 10 is a perspective view of a rotor of a second embodiment of a separation apparatus;

FIG. 11 is a cross-section view of the rotor of FIG. 10, along a diametric plane;

FIG. 12 is a top view of the rotor of FIG. 10.

FIG. 13 is a cross-section view of the rotor, as in FIG. 11, with the bag set of FIG. 1.

### DESCRIPTION OF THE EMBODIMENTS

For the sake of clarity, the invention will be described with respect to a specific use, namely the separation of whole blood into at least two components, in particular into a plasma component and a red blood cell component, or into a plasma component, a platelet component and a red blood cell component. The discrete volume mentioned hereunder will typically be the volume of a blood donation. The volume of a blood donation may vary from one donor to another one (450 ml plus or minus 10%). It is also recalled that the proportion of the components of blood usually varies from one donor to another one, in particular the hematocrit, which is the ratio of the volume of the red blood cells to the volume of the sample of whole blood considered. In other words the density of blood may slightly vary for one donor to another one. It should be understood however that this specific use is exemplary only.

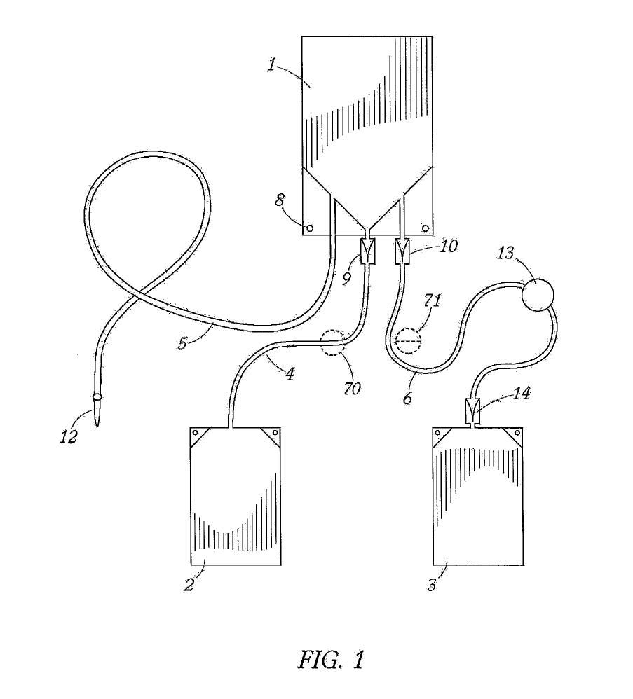

FIG. 1 shows an example of a set of bags adapted to the separation of a composite liquid (e.g. whole blood) into a first component (e.g. a plasma component containing or not a substantial amount of suspended platelets) and a second component (e.g. a blood cell component). This bag set comprises a flexible separation bag 1 and two flexible satellite bags 2, 3 connected thereto.

When the composite liquid is whole blood, the separation bag 1 has two purposes, and is successively used as a collection bag and as a separation bag. It is intended for initially receiving a discrete volume of whole blood from a donor (usually about 450 ml) and to be used later as a separation chamber in a separation apparatus. The separation bag 1 is flat and generally rectangular. It is made of two rectangular sheets of plastic material that are welded together so as to define therebetween an interior space having a main rectangular portion connected to a triangular top downstream portion. A first tube 4 is connected to the tip of the triangular portion, and second and third tubes 5, 6 are connected to either lateral edges of the triangular portion, respectively. The proximal ends of the three tubes 4, 5, 6 are embedded between the two sheets of plastic material so as to be parallel. The separation bag 1 further comprises a hole 8 in each of its corners that are adjacent to the three tubes 4, 5, 6. The holes 8 are used to secure the separation bag to a separation cell, as will be described later.

The separation bag initially contains a volume of anti-coagulant solution (typically about 63 ml of a solution of citrate phosphate dextrose for a blood donation of about 450 ml), and the first and third tubes 4, 6 are fitted at their proximal end with a breakable stopper 9, 10 respectively, blocking a liquid flow therethrough.

The second tube 5 is a collection tube having a needle 12 connected to its distal end. At the beginning of a blood donation, the needle 12 is inserted in the vein of a donor and blood flows into the collection (separation) bag 1. After a desired volume of blood has been collected in the collection (separation) bag 1, the collection tube 5 is sealed and cut.

The first satellite bag 2 is intended for receiving a plasma component. It is flat and substantially rectangular. It is connected to the distal end of the first tube 4.

The second satellite bag 3 is intended for receiving a red blood cell component. It is flat and substantially rectangular. It is connected to the distal end of the third tube 6. The third tube 6 comprises two segments respectively connected to the inlet and the outlet of a leuko-reduction filter 13. The second satellite bag 3 contains a volume of storage solution for red blood cells, and the third tube 6 is fitted at its distal end with a breakable stopper 14 blocking a liquid flow therethrough.

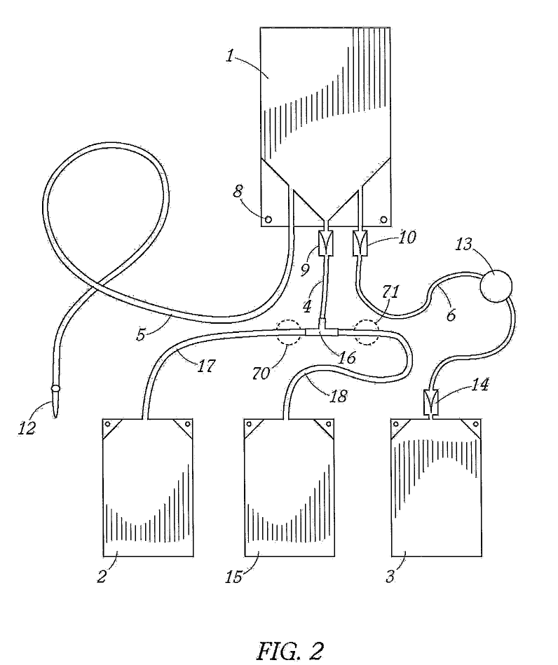

FIG. 2 shows an example of a set of bags adapted to the separation of a composite liquid (e.g. whole blood) into a first component (e.g. a plasma component), an intermediate component (e.g. a platelet component), and a second component (e.g. a red blood cell component). This bag set comprises a flexible separation bag 1 and three flexible satellite bags 2, 3, 15 connected thereto.

This second set of bags differs from the set of bags of FIG. 1 in that it comprises a third satellite bag 15, which is intended to receive a platelet component, and a T-shaped three-way connector 16 having its leg connected by the first tube 4 to the separation bag 1, a first arm connected by a fourth tube 17 to the first satellite bag 2 (plasma component bag), and a second arm connected by a fifth tube 18 to the third satellite bag 15 (platelet component bag). Like the first and second satellite bags 2, 3, the third satellite bag 15 is flat and substantially rectangular.

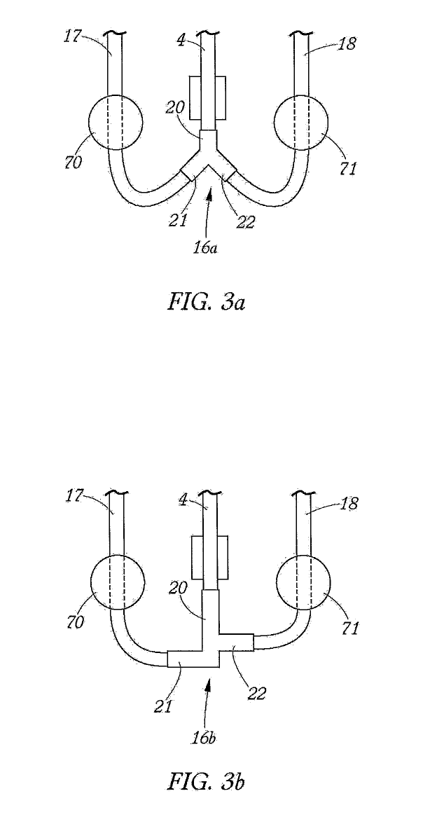

FIGS. 3a, 3b show two variants of the T-shaped three-way connector 16 of the bag set of FIG. 2.

The three-way connector 16a shown in FIG. 3a has the shape of a regular three-point star having a first outlet channel 21 and a second outlet channel 22 that are connected to an inlet channel 20 at an angle of about 120 degrees.

The three-way connector 16b shown in FIG. 3b, defines a first outlet channel 21 and a second outlet channel 22 that are perpendicularly connected to an inlet channel 20 and are offset along the inlet channel 20 so that the first outlet channel 21 is further than the second outlet channel 22 from the end of the inlet channel 20 that is connected to the first tube 4.

The three-way connectors 16, 16a, 16b are arranged such that when the separation bag of FIG. 2 (or any of its variants represented in FIG. 3a, 3b) is mounted in a separation apparatus (to be described in detail below), in which a separation cell for a separation bag 1, a storage container for the satellite bags 2, 3, 15, and a first and second pinch valve members for allowing or stopping a flow of liquid in the fourth and fifth tubes 17, 18 are arranged in this order along a radial direction from a rotation axis of the separation apparatus, with the pinch valve members being the closest to the rotation axis. In this particular configuration, when the fourth and fifth tubes 16, 17 are engaged in the first and second pinch valve members as shown in FIGS. 2, 3a, 3b, then the three-way connector 16, 16b, or a bend in the fourth and fifth tubes 17, 18 in the case of the connector of FIG. 3a, are the closest portion(s) of the whole bag set to the rotation axis. The results of this disposition are that, when the separation apparatus rotates, any air in the bag set will gather in the connector in an area that is the closest to the rotation axis (junction point of the three channels 20, 21, 22 in the connectors shown in FIGS. 2, 3b) or in the bends in the fourth and fifth tube 17, 18 between the connector and the pinch valve members 17, 18 when the connector used is the connector of FIG. 3a. This air buffer between the separation bag and the satellite bag will prevent any undesirable siphoning of contents of a satellite bag into the separation bag under centrifugation forces.

The three-way connector 16b presents a particular interest when the bag set of FIG. 2 is used to separate a plasma component and a platelet component. When the plasma component has been transferred into the first satellite bag 2 and the platelet component has been transferred into the third satellite bag 15, the connector 16b shown in FIG. 3b allow for flushing the second channel 22, which may contain remaining platelets, with a small volume of plasma trapped in the fourth tube 17 between the connector 16b and the first pinch valve member.

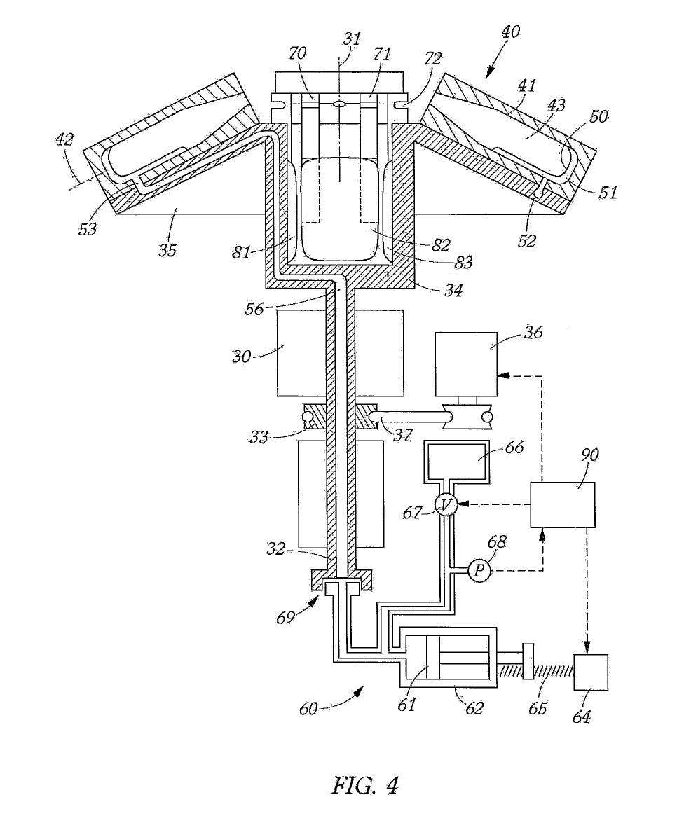

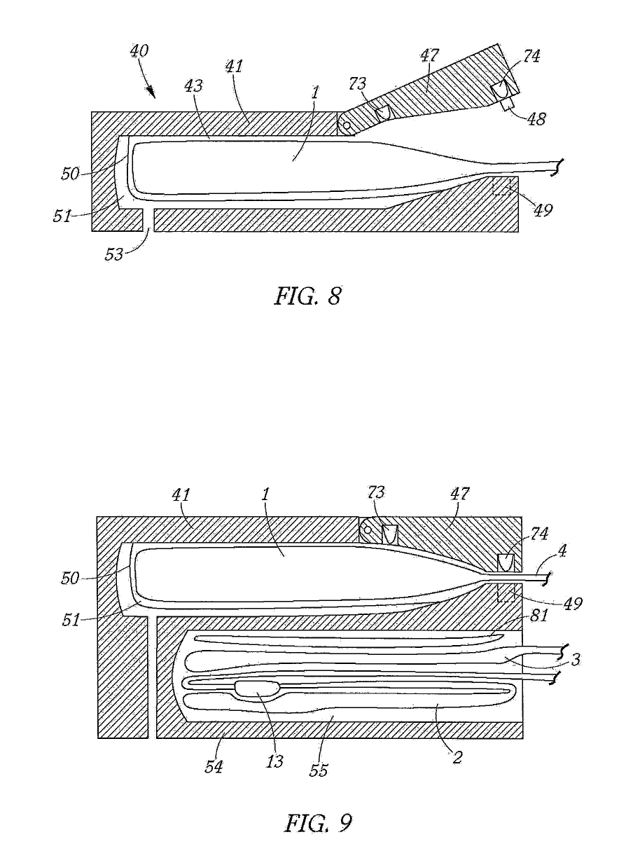

FIGS. 4, 5, 6, and 8 show a first embodiment of an apparatus for simultaneously separating by centrifugation four discrete volumes of a composite liquid. The apparatus comprises: a centrifuge adapted to receive four of either set of bags shown in FIGS. 1 and 2, with the four discrete volumes of a composite liquid contained in the four separation bags; a component transferring means for transferring at least one separated component from each separation bag into a satellite bag connected thereto; a first balancing means for initially balancing the rotor when the weights of the four separation bags are different; and a second balancing means for balancing the rotor when the weights of the separated components transferred into the satellite bags cause an unbalance of the rotor.

The centrifuge comprises a rotor that is supported by a bearing assembly 30 allowing the rotor to rotate around a rotation axis 31. The rotor comprises: a cylindrical rotor shaft 32 to which a pulley 33 is connected; a storage means comprising a central cylindrical container 34 for containing satellite bags, which is connected to the rotor shaft 32 at the upper end thereof so that the longitudinal axis of the rotor shaft 32 and the longitudinal axis of the container 34 coincide with the rotation axis 31, and a frusto-conical turntable 35 connected to the upper part of the central container 34 so that its central axis coincides with the rotation axis 31. The frusto-conical turntable 35 flares underneath the opening of the container 34. Four identical separation cells 40 are mounted on the turntable 35 so as to form a symmetrical arrangement with respect to the rotation axis 31.

The centrifuge further comprises a motor 36 coupled to the rotor by a belt 37 engaged in a groove of the pulley 33 so as to rotate the rotor about the rotation axis 31.

Each separation cell 40 comprises a container 41 having the general shape of a rectangular parallelepiped. The separation cells 40 are mounted on the turntable 35 so that their respective median longitudinal axes 42 intersect the rotation axis 31, so that they are located substantially at the same distance from the rotation axis 31, and so that the angles between their median longitudinal axes 42 are substantially the same (i.e. 90 degrees). The exact position of the separation cells 40 on the turntable 35 is adjusted so that the weight on the turntable is equally distributed when the separation cells 40 are empty, i.e. so that the rotor is balanced. It results from the arrangement of the separating cells 40 on the turntable 35 that the separating cells 40 are inclined with respect to the rotation axis 31 of an acute angle equal to the angle of the frustum of a cone that geometrically defines the turntable 35.

Each container 41 comprises a cavity 43 that is so shaped and dimensioned as to loosely accommodate a separation bag 1 full of liquid, of the type shown in FIGS. 1 and 2. The cavity 43 (which will be referred to later also as the “separation compartment”) is defined by a bottom wall that is the farthest to the rotation axis 31, a lower wall that is the closest to the turntable 35, an upper wall opposite to the lower wall, and two lateral walls. The cavity 43 comprises a main part, extending from the bottom wall, which has substantially the shape of a rectangular parallelepiped with rounded angles, and an upper part, which has substantially the shape of a prism having convergent triangular bases. In other words, the upper part of the cavity 43 is defined by two couples of opposite walls converging towards the central median axis 42 of the cavity 43. One interest of this design is to cause a radial dilatation of the thin layer of a minor component of a composite fluid (e.g. the platelets in whole blood) after separation by centrifugation, and makes it more easily detectable in the upper part of a separation bag. The two couples of opposite walls of the upper part of the separation cell 40 converge towards three cylindrical parallel channels 44, 45, 46, opening at the top of the container 41, and in which, when a separation bag 1 is set in the container 41, the three tubes 4, 5, 6 extend.

The container 41 also comprises a hinged lateral lid 47, which is comprised of an upper portion of the external wall of the container 41, i.e. the wall that is opposite to the turntable 35. The lid 47 is so dimensioned as to allow, when open, an easy loading of a separation bag 1 full of liquid into the separation cell 40. The container 41 comprises a fast locking means (not shown) by which the lid 47 can be locked to the remaining part of the container 41.

The container 41 also comprises a securing means for securing a separation bag 1 within the separation cell 40. The bag securing means comprises two pins 48 protruding on the internal surface of the lid 47, close to the top of separation cell 40, and two corresponding recesses 49 in the upper part of the container 41. The two pins 48 are so spaced apart and dimensioned as to fit into the two holes 8 in the upper corner of a separation bag 1.

The separation apparatus further comprises a component transferring means for transferring at least one separated component from each separation bag into a satellite bag connected thereto. The component transferring means comprises a squeezing system for squeezing the separation bags 1 within the separation compartments 43 and causing the transfer of separated components into satellite bags 2, 3, 15.

The squeezing system comprises a flexible diaphragm 50 that is secured to each container 41 so as to define an expandable chamber 51 in the cavity thereof. More specifically, the diaphragm 50 is dimensioned so as to line the bottom wall of the cavity 43 and a large portion of the lower wall of the cavity 43, which is the closest to the turntable 35.

The squeezing system further comprises a peripheral circular manifold 52 that forms a ring within the turntable 35 extending close to the periphery of the turntable 35. Each expansion chamber 51 is connected to the manifold 52 by a supply channel 53 that extends through the wall of the respective container 41, close to the bottom thereof.

The squeezing system further comprises a hydraulic pumping station 60 for pumping a hydraulic liquid in and out the expandable chambers 51 within the separation cells 40. The hydraulic liquid is selected so as to have a density slightly higher than the density of the more dense of the components in the composite liquid to be separated (e.g. the red blood cells, when the composite liquid is blood). As a result, during centrifugation, the hydraulic liquid within the expandable chambers 51, whatever the volume thereof, will generally remain in the most external part of the separation cells 40. The pumping station 60 is connected to the expandable chambers 51, through a rotary seal 69, by a duct 56 that extends through the rotor shaft 32, the bottom and lateral wall of the central container 34, and, from the rim of the central container 34, radially through the turntable 35 where it connects to the manifold 52.

The pumping station 60 comprises a piston pump having a piston 61 movable in a hydraulic cylinder 62 fluidly connected via a rotary fluid coupling 63 to the rotor duct 54. The piston 61 is actuated by a stepper motor 64 that moves a lead screw 65 linked to the piston rod. The hydraulic cylinder 62 is also connected to a hydraulic liquid reservoir 66 having an access controlled by a valve 67 for selectively allowing the introduction or the withdrawal of hydraulic liquid into and from a hydraulic circuit including the hydraulic cylinder 62, the rotor duct 56 and the expandable hydraulic chambers 51. A pressure gauge 68 is connected to the hydraulic circuit for measuring the hydraulic pressure therein.

The separation apparatus further comprises four pairs of first and second pinch valve members 70, 71 that are mounted on the rotor around the opening of the central container 34. Each pair of pinch valve members 70, 71 faces one separation cell 40, with which it is associated. The pinch valve members 70, 71 are designed for selectively blocking or allowing a flow of liquid through a flexible plastic tube, and selectively sealing and cutting a plastic tube. Each pinch valve member 70, 71 comprises an elongated cylindrical body and a head having a groove 72 that is defined by a stationary upper jaw and a lower jaw movable between an open and a closed position. The groove 72 is so dimensioned that one of the tubes 4, 17, 18 of the bag sets shown in FIGS. 1 and 2 can be snuggly engaged therein when the lower jaw is in the open position. The elongated body contains a mechanism for moving the lower jaw and it is connected to a radio frequency generator that supplies the energy necessary for sealing and cutting a plastic tube. The pinch valve members 70, 71 are mounted inside the central container 34, adjacent the interior surface thereof, so that their longitudinal axes are parallel to the rotation axis 31 and their heads protrude above the rim of the container 34. The position of a pair of pinch valve members 70, 71 with respect to a separation bag 1 and the tubes 4, 17, 18 connected thereto when the separation bag 1 rests in the separation cell 40 associated with this pair of pinch valve members 70, 71 is shown in doted lines in FIGS. 1 and 2. Electric power is supplied to the pinch valve members 70, 71 through a slip ring array 38 that is mounted around a lower portion of the rotor shaft 32.

The separation apparatus further comprises four pairs of sensors 73, 74 for monitoring the separation of the various components occurring within each separation bag when the apparatus operates. Each pair of sensors 73, 74 is embedded in the lid 47 of the container 41 of each separation cell 40 along the median longitudinal axis 42 of the container 41, a first sensor 73 being located the farthest and a second sensor 74 being located the closest to the rotation axis 31. When a separation bag 1 rests in the container 41 and the lid 47 is closed, the first sensor 73 (later the bag sensor) faces the upper triangular part of the separation bag 1 and the second sensor 74 (later the tube sensor) faces the proximal end of the first tube 4. The bag sensor 73 is able to detect blood cells in a liquid. The tube sensor 74 is able to detect the presence of absence of liquid in the tube 4 as well as to detect blood cells in a liquid. Each sensor 73, 74 may comprise a photocell including an infrared LED and a photodetector. Electric power is supplied to the sensors 73, 74 through the slip ring array 38 that is mounted around the lower portion of the rotor shaft 32.

The separation apparatus further comprises a first balancing means for initially balancing the rotor when the weights of the four separation bags 1 contained in the separation cells 40 are different. The first balancing means substantially comprises the same structural elements as the elements of the component transferring means described above, namely: four expandable hydraulic chambers 51 interconnected by a peripheral circular manifold 52, and a hydraulic liquid pumping station 60 for pumping hydraulic liquid into the hydraulic chambers 51 through a rotor duct 56, which is connected to the circular manifold 52. In order to initially balance the rotor, whose four separation cells 40 contain four discrete volumes of a composite liquid that may not have the same weight (because the four volumes may be not equal, and/or the density of the liquid may slightly differ from one volume to the other one), the pumping station 60 is controlled so as to pump into the interconnected hydraulic chambers 51, at the onset of a separation process, a predetermined volume of hydraulic liquid that is so selected as to balance the rotor in the most unbalanced situation. For whole blood, the determination of this balancing volume takes into account the maximum difference in volume between two blood donations, and the maximum difference in hematocrit (i.e. in density) between two blood donations. Under centrifugation forces, the hydraulic liquid will distribute unevenly in the four separation cells 40 depending on the difference in weight of the separation bags 1, and balance the rotor. In order to get an optimal initial balancing, the volume of the cavity 43 of the separation cells 40 should be selected so that the cavities 43, whatever the volume of the separation bags 1 contained therein, are not full after the determined amount of hydraulic liquid has been pumped into the interconnected expansion chambers 51.

The separation apparatus further comprises a second balancing means, for balancing the rotor when the weights of the components transferred into the satellite bags 2, 3, 15 in the central container 34 are different. For example, when two blood donations have the same hematocrit and different volumes, the volumes of plasma extracted from each donation are different, and the same is true when two blood donations have the same volume and different hematocrit. As shown in FIGS. 4, 5, 6 the second balancing means comprises four flexible rectangular pouches 81, 82, 83, 84 that are interconnected by four tube sections 85, 86, 87, 88, each tube section connecting two adjacent pouches by the bottom thereof. The pouches 81, 82, 83, 84 contain a volume of balancing liquid having a density close to the density of the composite liquid. The volume of balancing liquid is so selected as to balance the rotor in the most unbalanced situation. The four pouches 81, 82, 83, 84 are so dimensioned as to line the inner surface of the central container 34 and to have an internal volume that is larger than the volume of balancing liquid so that the balancing liquid can freely expand in any of the pouches 81, 82, 83, 84. In operation, if, for example, four satellite bags 2 respectively adjacent to the four pouches 81, 82, 83, 84 receive different volumes of a plasma component, the four satellite bags 2 will press unevenly, under centrifugation forces, against the four pouches 81, 82, 83, 84, which will result in the balancing liquid becoming unevenly distributed in the four pouches 81, 82, 83, 84 and compensating for the difference in weight in the satellite bags 2.

The separation apparatus further comprises a controller 90 including a control unit (e.g. a microprocessor) and a memory unit for providing the microprocessor with information and programmed instructions relative to various separation protocols (e.g. a protocol for the separation of a plasma component and a blood cell component, or a protocol for the separation of a plasma component, a platelet component, and a red blood cell component) and to the operation of the apparatus in accordance with such separation protocols. In particular, the microprocessor is programmed for receiving information relative to the centrifugation speed(s) at which the rotor is to be rotated during the various stages of a separation process (e.g. stage of component separation, stage of a plasma component expression, stage of suspension of platelets in a plasma fraction, stage of a platelet component expression, etc), and information relative to the various transfer flow rates at which separated components are to be transferred from the separation bag 1 into the satellite bags 2, 3, 15. The information relative to the various transfer flow rates can be expressed, for example, as hydraulic liquid flow rates in the hydraulic circuit, or as rotation speeds of the stepper motor 64 of the hydraulic pumping station 60. The microprocessor is further programmed for receiving, directly or through the memory, information from the pressure gauge 68 and from the four pairs of photocells 73, 74 and for controlling the centrifuge motor 36, the stepper motor 64 of the pumping station 60, and the four pairs of pinch valve members 70, 71 so as to cause the separation apparatus to operate along a selected separation protocol.

Variants of the first embodiment of the separation apparatus described above are as follows:

Instead of the centralized hydraulic squeezing system described above, a separation apparatus can be fitted with as many independent squeezing means as separation cells 40. An independent squeezing means may be comprised, for example, of a plate that can be moved by any electro-magnetic, electro-mechanical or hydraulic mechanism so as to squeeze a separation bag against a wall of the cavity 43 of the container 41 of a separation cell 40.

Instead of a system of interconnected hydraulic chambers or pouches, the first and/or second balancing means can comprise a ball balancer including a circular cage in which heavy balls can move freely. The circular cage is mounted on the rotor so as to be centered on the rotation axis 31.

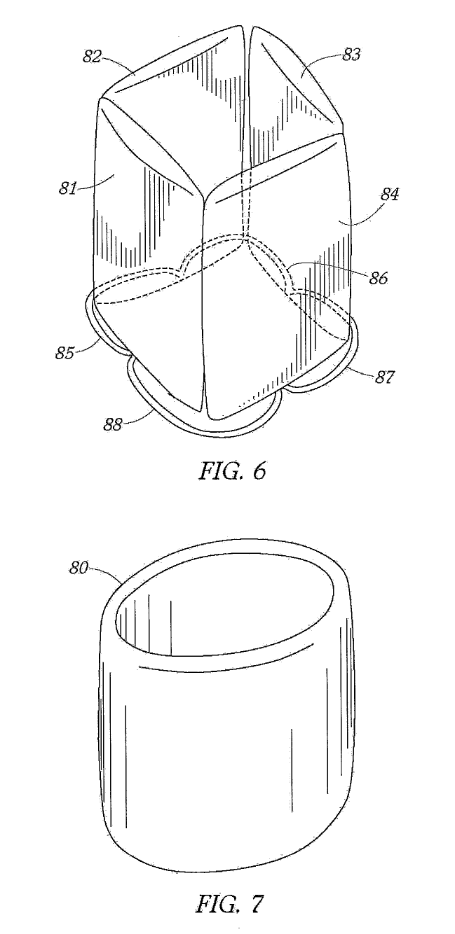

Instead of a central container 34 for containing all the satellite bags 2, 3, 15 connected to the separation bags 1, a separation apparatus can comprise as many satellite bag containers as separation cells. FIG. 9 shows a container arrangement that can be used in such a separation apparatus. The container arrangement of FIG. 9 comprises a separation bag container 41 that is connected to or is made integral with a satellite bag container 54. The satellite bag container 54 comprises a cavity 55 having the shape of a rectangular parallelepiped, which contains a pouch 81 of a balancing assembly as shown in FIG. 6. The separation bag container 41 is superimposed on the satellite bag container 54 so that the openings of both containers are in the same plane, facing the rotation axis 31 when the container arrangement is mounted on a rotor turntable 35.

The second sensors 74 can be embedded in the lids 47 of the containers 41 so as to face an upper part of a separation bag 1 close to the connection thereof to the first tube 4.

The diaphragm 50, instead of being secured to the container 41 so as to line a portion of the lower wall of the cavity 43, can be secured to the container 41 so as to line a portion of the upper wall of the cavity 43.

In each separation cell 40, the hydraulic chamber 51, instead of being defined by a flexible diaphragm 50 lining the bottom wall of the cavity 43 and a large portion of the lower wall of the cavity 43, can comprise a flexible pouch similar to a pouch of the second balancing means.

The second balancing means, instead of comprising four interconnected pouches 81, 82, 83, 84 as shown in FIG. 6, can comprise a flexible tubular pouch 80 having two concentric walls as shown in FIG. 7. The pouch 80 is so dimensioned as to line the inner surface of the central container 34 and to have an internal volume that is larger than the volume of balancing liquid so that the balancing liquid can freely expand in one area of pouch or in another.

The pumping station 60, instead of a piston pump 61, 62, can comprise any pump (e.g. a positive displacement pump) whose output can be controlled with sufficient accuracy.

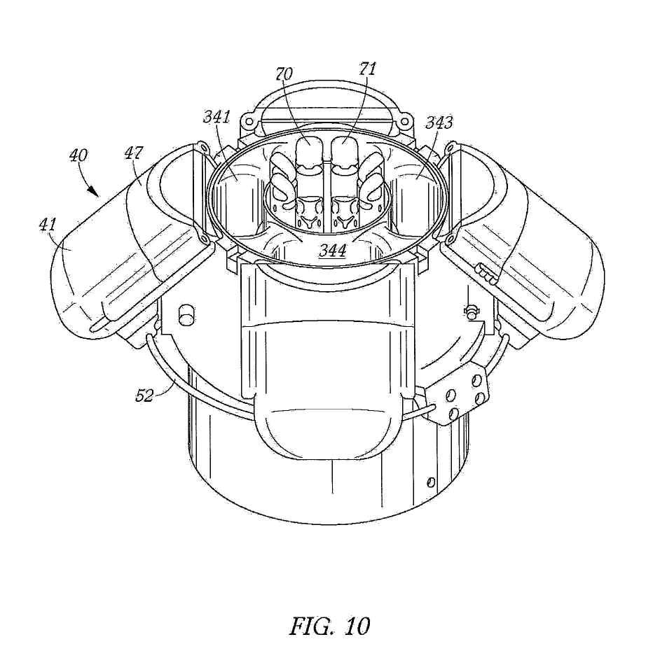

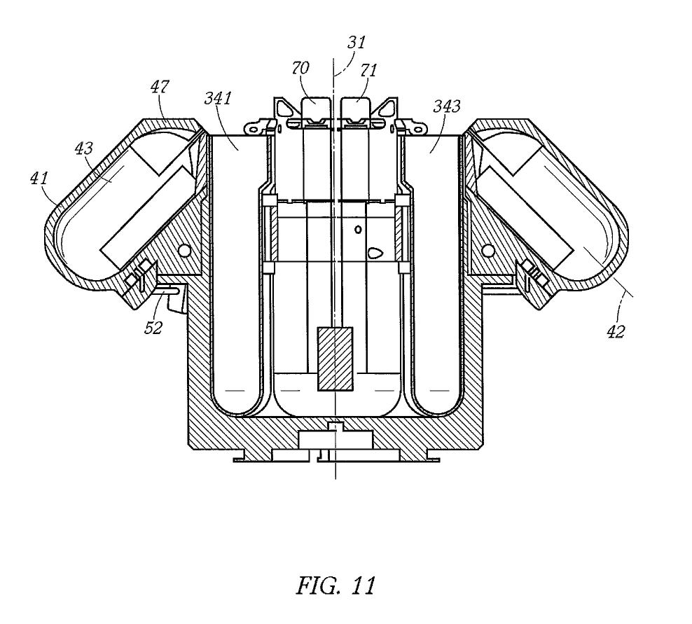

FIGS. 10, 11, and 12 show the rotor of a second embodiment of a separation apparatus for four discrete volumes of a composite liquid.

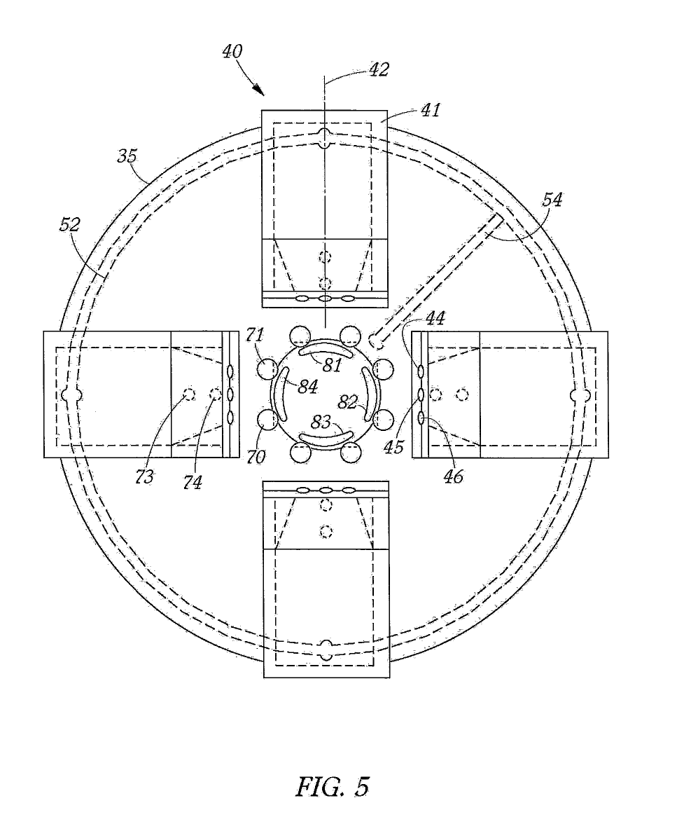

The rotor of this second embodiment essentially differs from the rotor of the embodiment of FIGS. 4 and 5 in the spatial arrangement of the pinch valve members 70, 71 and of the storage means for the satellite bags with respect to the separation cells 40. In this embodiment, the storage means, instead of comprising a central container, comprises four satellite containers 341, 342, 343, 344 that are arranged around a central cylindrical cavity 340, in which the four pairs of pinch valve member 70, 71 are mounted with their longitudinal axes parallel to the rotation axis 31. The cavity 43 of a satellite container 341, 342, 343, 344 has a regular bean-like cross-section, and a central longitudinal axis that is parallel to the rotation axis 31 and intersects the longitudinal axis 42 of the associated separation cell 40.

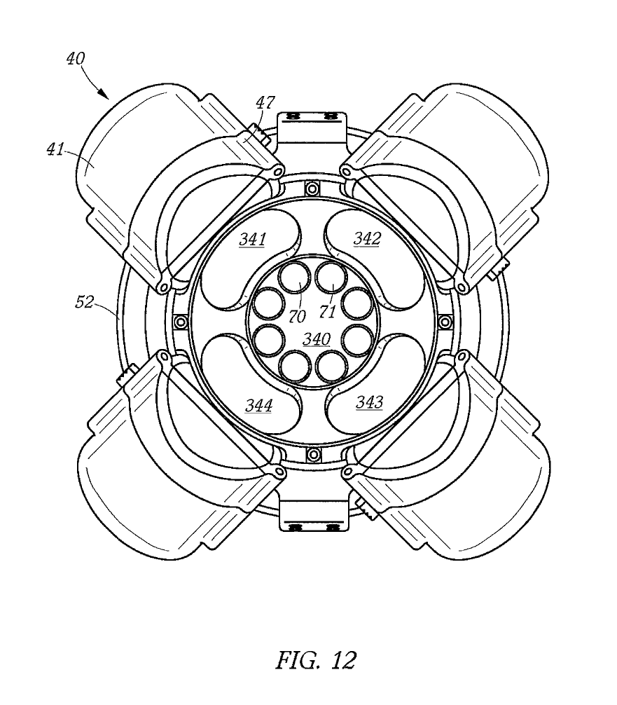

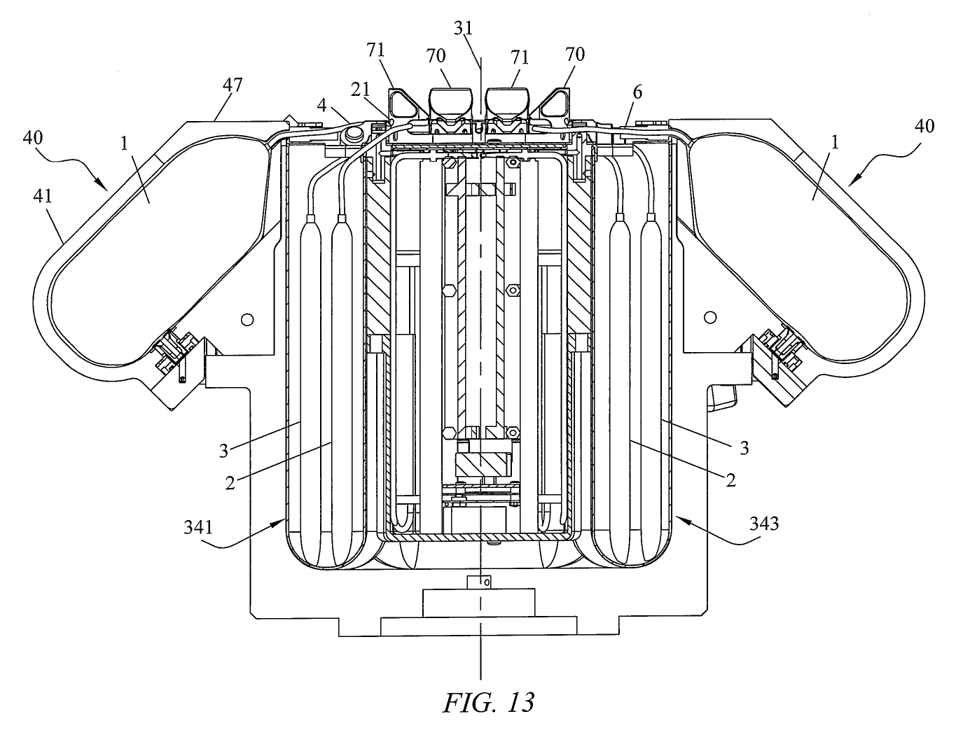

When a set of bag as shown in FIGS. 2, 3a, 3b is mounted on the rotor of FIGS. 11 to 12, the separation bag 1 and the satellite bags 2, 3, 15 are located beyond the associated pinch valves members 70, 71 with respect to the rotation axis 31. The tubes 4, 17, 18 and the three-way connector 16, 16a, 16b connecting the bags are then in the position shown in FIGS. 2, 3a, 3b and in FIG. 13. The bag set, and in particular the separation bag, is connected to no other source of fluid to be processed, except the fluid contained in the separation bag.

When each separation cell 40 and an associated satellite container 341, 342, 343, 344 for receiving component bags are located radially outwardly from a set of valves 70, 71 associated with the separation cell 40 and its satellite container 341, 342, 343, 344, the longitudinal axis of the cavity of each separation cell 40 intersects the rotation axis 31 of the rotor at an acute angle. Preferably, the acute angle is about 45 degrees. A set of bags, comprising a separation bag 1 and at least one component or satellite bag 2, 3, 15 connected by a tube 4, 17, 18, are mounted on the rotor. The separation bag is placed in the separation cell, while the component bag is placed in the container. The separation bag is the sole source of blood or biologic fluid to be processed by the apparatus. The connecting tube 17, 18 passes through the pinch valve 70, 71 and is, therefore, constrained to lie radially inwardly from both the separation bag and the component bag and also above both the separation bag and the component bag or bags. Rotating the rotor creates a centrifugal field, directed outwardly from the center of rotation. In this condition, at least a portion of the connecting tube is always “higher” than both the separation bag and the component bag, that is, the connecting tube is closer to the center of rotation 31 than both of the bags. Moreover, the separation bag is not connected to any other source of fluid, which might be “higher” than either the separation bag or the component bag or the connecting tube. Any air in the set of bags, therefore, will collect in the highest point in the tube, so long as the centrifugal field exists. In addition, at least a portion of the connecting tube is always “above” both the separation bag and the component bag with respect to the axis of rotation of the rotor when the rotor is stopped, that is, when the apparatus is only subject to the gravitational field of the earth. In other words, at least a portion of the connecting tube is “axially above” all the bags of the bag set. Any air in the set of bags will collect in the “highest” (as defined above) point in the tube, so long as the centrifugal field exists. Any air in the set of bags will collect in the point or portion of the tube “axially above” (as defined above) the set of bags, when the centrifugal field does not exist and the apparatus is subject only to the earth's gravitational field. The presence of air at the high point of the tube, during centrifugation, and at at least a portion of the tube axially above the set of bags when the rotor is stopped prevents a siphon effect from developing between the separation bag and the component bag. Preferably, the high point of the tube and the portion of the tube axially above the set of bags are the same.

The operation of the separation apparatus of FIGS. 3 and 4, in accordance to a first and second illustrative separation protocols, will be described now. These protocols are equally applicable to the embodiment of FIGS. 10, 11, and 12

According to a first separation protocol, four discrete volumes of blood are separated into a plasma component, a first cell component comprising platelets, white blood cells, some red blood cells and a small volume of plasma (later the “buffy coat” component) and a second cell component mainly comprising red blood cells. Each volume of blood is contained in a separation bag 1 of a bag set represented in FIG. 2, in which it has previously been collected from a donor using the collection tube 5. After the blood collection, the collection tube 5 has been sealed and cut close to the separation bag. Typically, the volumes of blood are not the same in the four separation bags 1, and the hematocrit varies from one separation bag 1 to another one. Consequently, the separation bags 1 have slightly different weights.

First stage (first protocol): setting the four-bag sets in the separation apparatus.

Four separation bags 1 are loaded into the four separation cells 40. The lids 47 are closed and locked, whereby the separation bags 1 are secured by their upper edge to the containers 41 (the pins 48 of the securing means pass then through the holes 8 in the upper corner of the separation bags 1 and engage the recesses 49 or the securing means).

The tubes 17 connecting the separations bags 1 to the plasma component bags 2, through the T connectors 16, are inserted in the groove 72 of the first pinch valve members 70. The tubes 18 connecting the separations bags 1 to the buffy coat component bags 15, through the T connector 16, are inserted in the groove 72 of the second pinch valve members 71. The four plasma component bags 2, the four buffy coat component bags 15, the four red blood cell component bags 3 and the four leuko-reduction filters 13 are inserted in the central compartment 34 of the rotor. The four plasma component bags 2 are respectively placed in direct contact with the pouches 81 to 84 of the second balancing means. The pinch valve members 70, 71 are closed and the breakable stoppers 9 in the tubes 4 connecting the separation bags 1 to the T connectors 16 are manually broken.

Second stage (first protocol): balancing the rotor in order to compensate for the difference in weights of the separation bags

At the onset of the second stage, all the pinch valve members 70, 71 are closed. The rotor is set in motion by the centrifuge motor 36 and its rotation speed increases steadily until it rotates at a first centrifugation speed. The pumping station 60 is actuated so as to pump a predetermined overall volume of hydraulic liquid into the four hydraulic chambers 51, at a constant flow rate. This overall volume of liquid is predetermined taking into account the maximum variation of weight between blood donations, so that, at the end of the second stage, the weights in the various separation cells 40 are substantially equal and the rotor is substantially balanced, whatever the specific weights of the separation bags 1 that are loaded in the separation cells 40. Note that this does not imply that the internal cavity 43 of the separation cells 40 should be filled up at the end of the balancing stage. For the purpose of balancing the rotor, it suffices that there is enough hydraulic liquid in the separation cells 40 for equalizing the weights therein, and it does not matter if an empty space remains in each separation cell 40 (the size of this empty space essentially depends on the volume of the internal cavity 43 of a separation cell 40 and the average volume of a blood donation). Because the hydraulic chambers 51 are interconnected, the distribution of the overall volume of hydraulic liquid between the separations chambers 40 simply results from the rotation of the rotor. When the weights of the separation bags 1 are the same, the distribution of the hydraulic liquid is even. When they are not, the distribution of the hydraulic liquid is uneven, and the smaller the weight of a specific separation bag 1, the larger the volume of the hydraulic fluid in the associated hydraulic chamber 51.

Third stage (first protocol): the blood within the separation bags 1 is sedimented to a desired level.

At the onset of this stage, all pinch valve members 70, 71 are closed. The rotor is rotated at a second centrifugation speed (high sedimentation speed or “hard spin”) for a predetermined period of time that is so selected that, whatever the hematocrit of the blood in the separation bags 1, the blood sediments in each of the separation bag 1 at the end of the selected period to a point where the hematocrit of the outer red blood cell layer is about 90 and the inner plasma layer does not substantially contain anymore cells, the platelets and the white blood cells forming then an intermediary layer between the red blood cell layer and the plasma layer.

Fourth stage (first protocol): a plasma component is transferred into the plasma component bags 2.

At the onset of this stage, the rotation speed is decreased to a third centrifugation speed, the four first pinch valve members 70 controlling access to the plasma component bags 2 are opened, and the pumping station 60 is actuated so as to pump hydraulic liquid at a first constant flow rate into the hydraulic chambers 51 and consequently squeeze the separation bags 1 and cause the transfer of plasma into the plasma component bags 2.

When blood cells are detected by the bag sensor 73 in the separation cell 40 in which this detection occurs first, the pumping station 60 is stopped and the corresponding first pinch valve member 70 is closed, either immediately of after a predetermined amount of time selected in view of the volume of plasma that it is desirable in the buffy coat component to be expressed in a next stage.

Following the closure of the first (first) pinch valve member 70 (i.e. the first pinch valve of the group of first pinch valve members 70) to close, the pumping station 60 is actuated anew so as to pump hydraulic liquid at a second, lower, flow rate into the hydraulic chambers 51 and consequently squeeze the three separation bags 1 whose outlet is not closed by the corresponding first pinch valve members 70.

When blood cells are detected by the bag sensor 73 in the separation cell 40 in which this detection occurs second, the pumping station 60 is stopped and the corresponding first pinch valve member 70 is closed (same timing as for the closing of the first (first) pinch valve member to close).

Following the closure of the second (first) pinch valve member 70 to close, the pumping station 60 is actuated anew so as to pump hydraulic liquid at the second flow rate into the hydraulic chambers 51 and consequently squeeze the two separation bags 1 whose outlet is not closed by the corresponding first pinch valve members 70.

When blood cells are detected by the bag sensor 73 in the separation cell 40 in which this detection occurs third, the pumping station 60 is stopped and the corresponding first pinch valve member 70 is closed (same timing as for the closing of the first (first) pinch valve member to close).

Following the closure of the third (first) pinch valve member 70 to close, the pumping station 60 is actuated anew so as to pump hydraulic liquid at the second flow rate into the hydraulic chambers 51 and consequently squeeze the separation bag 1 whose outlet is not yet closed by the corresponding first pinch valve member 70.

When blood cells are detected by the bag sensor 73 in the separation cell 40 in which this detection occurs last, the pumping station 60 is stopped and the corresponding first pinch valve member 70 is closed (same timing as for the closing of the first pinch valve member to close).

In the plasma component transfer process described above, the transfer of the four plasma components starts at the same time, run in part simultaneously and stop independently of each other upon the occurrence of a specific event in each separation bag (detection of blood cells by the bag sensor).

As a variant, when the second flow rate is sufficiently low and the closing of the first pinch valve member 70 occurs almost simultaneously with the detection of blood cells in the separation bags, then the pumping station can be continuously actuated during the fourth stage.

The fourth stage ends when the four first pinch valve members 70 are closed.

Fifth stage (first protocol): a buffy coat component is transferred into the buffy coat component bags 15.

The control unit 90 is programmed to start the fifth stage after the four first pinch valve members 70 are closed, upon receiving information from the last bag sensor 73 to detect blood cells.

At the onset of this stage, the rotation speed remains the same (third centrifugation speed), a first of the four second pinch valve members 71 controlling access to the buffy coat component bags 15 is opened, and the pumping station 60 is actuated so as to pump hydraulic liquid at a third constant flow rate into the hydraulic chambers 51 and consequently squeeze the separation bag 1 in the separation cell 40 associated with the opened second pinch valve members 71 and cause the transfer of the buffy coat component into the buffy coat component bag 2 connected to this separation bag 1.

After a predetermined period of time after blood cells are detected by the tube sensor 74 in the separation cell 40 associated with the opened second pinch valve member 71, the pumping station 60 is stopped and the second pinch valve member 71 is closed.

After the first (second) pinch valve member 71 has closed (i.e. the first pinch valve of the group of second pinch valve members 71), a second (second) pinch valve member 71 is opened, and a second buffy coat component is transferred into a buffy coat component bag 2, in the same way as above.

The same process is successively carried out to transfer the buffy coat component from the two remaining separation bags 1 into the buffy coat component bag 2 connected thereto.

In the buffy coat component transfer process described above, the transfers of the four buffy coat components are successive, and the order of succession is predetermined. However, each of the second, third and four transfers starts following the occurrence of a specific event at the end of the previous transfer (detection of blood cells by the tube sensor 74 or closing of the second valve member 71).

As a variant, when the third flow rate is sufficiently low and the closing of the second pinch valve members 71 occurs almost simultaneously with the detection of blood cells in the tubes 4, then the pumping station can be actuated continuously during the fourth stage.

As a variant, the control unit 90 is programmed to start the fifth stage after a predetermined period of time after receiving information from the first (or the second or the third) bag sensor 73 to detect blood cells. The period of time is statistically or empirically determined so that, whatever the event from which it starts running (detection of the blood cells by either one of the first, second, and third bag sensor 73 to detect blood cells), the four first pinch valve members 70 are closed when it is over.

The fifth stage ends when the four second pinch valve members 71 are closed.

Sixth stage (first protocol): the centrifugation process is ended.

The control unit 90 is programmed to start the sixth stage after the four (second) pinch valve members 71 are closed, upon receiving information from the last tube sensor 74 to detect blood cells.

The rotation speed of the rotor is decreased until the rotor stops, the pumping station 60 is actuated so as to pump the hydraulic liquid from the hydraulic chambers 51 at a high flow rate until the hydraulic chambers 51 are empty, and the first and second pinch valve members 70, 71 are actuated so as to seal and cut the tubes 17, 18. The blood cells remain in the separation bags 1.

When the fifth stage is completed, the four bag sets are removed from the separation apparatus and each bag set is separately handled manually.

The breakable stopper 10 blocking the communication between the separation bag 1 and the tube 6 connected thereto is broken, as well as the breakable stopper 14 blocking the communication between the second satellite bag 3 and the tube 6. The storage solution contained in the second satellite bag 3 is allowed to flow by gravity through the leuko-reduction filter 13 and into the separation bag 1, where it is mixed with the red blood cells so as to lower the viscosity thereof. The content of the separation bag 1 is then allowed to flow by gravity through the filter 13 and into the second satellite bag 3. The white blood cells are trapped by the filter 13, so that substantially only red blood cells are collected into the second satellite bag 3.

As a variant, the control unit 90 is programmed to start the sixth stage after a predetermined period of time after receiving information from the first (or the second or the third) tube sensor 74 to detect blood cells. The period of time is statistically or empirically determined so that, whatever the event from which it starts running (detection of the blood cells by either one of the first, second, and third tube sensor 74 to detect blood cells), the four second pinch valve members 71 are closed when it is over.

According to a second separation protocol, four discrete volumes of blood are separated into a plasma component, a platelet component and a red blood cell component. Each volume of blood is contained in a separation bag 1 of a bag set represented in FIG. 2, in which it has previously been collected from a donor using the collection tube 5. After the blood collection, the collection tube 5 has been sealed and cut close to the separation bag 1. Typically, the volumes of blood are not the same in the four separation bags 1, which, consequently, have slightly different weights. Also, typically, the hematocrit varies from one separation bag 1 to another one.

First stage (second protocol): setting the four-bag sets in the separation apparatus.

This stage is identical to the first stage of the first protocol.

Second stage (second protocol): balancing the rotor in order to compensate for the difference in weights of the separation bags

This stage is identical to the second stage of the first protocol.

Third stage (second protocol): the blood within the separation bags 1 is sedimented to a desired level.

This stage is identical to the third stage of the first protocol.

Fourth stage (second protocol): a first, larger, portion of plasma is transferred into the plasma bags 2, while a second, smaller, portion of plasma remains in the separation bags 1.

This stage is substantially the same as the fourth stage of the first protocol. However, the expression of plasma from each separation bag 1 into the attached plasma component bag 2 is stopped immediately after detection of blood cells by the corresponding bag sensor 73, so that the volume of plasma remaining in the separation bag 1 is large enough to allow the platelets to be re-suspended therein.

Fifth stage (second protocol): a platelet component is prepared in the separation bag 1.

At the onset of this fifth stage, the first and second valve members 70, 71 are closed. The rotor is stopped and the pumping station 60 is actuated so as to pump a volume of hydraulic liquid from the hydraulic chambers 51 at a high flow rate. The rotor is then controlled so as to oscillate back and forth around the rotation axis 31 for a determined period of time, at the end of which the cells in the separation bags 1 are substantially suspended in plasma. The rotor is then set in motion again by the centrifuge motor 36 so that its rotation speed increases steadily until it reaches a fourth centrifugation speed (low sedimentation speed or “soft spin”). The rotor is rotated at the fourth rotation speed for a predetermined period of time that is selected so that the blood sediments in the separation bags 1 at the end of the selected period to a point where the separation bags 1 exhibit an outer layer comprising packed red blood cells and an inner annular layer substantially comprising platelets suspended in plasma.

Sixth stage (second protocol): a platelet component is transferred into the platelet bags 15.

This stage is substantially the same as the fifth stage of the first protocol (buffy coat expression).

Seventh stage (second protocol): the centrifugation process is ended. This stage is substantially the same as the sixth stage of the first protocol.

It will be apparent to those skilled in the art that various modifications can be made to the apparatus and method described herein. Thus, it should be understood that the invention is not limited to the subject matter discussed in the specification. Rather, the present invention is intended to cover modifications and variations.

1. An apparatus for separating blood or blood components into at least a first component and a second component, the apparatus comprising a centrifuge having
a rotor having an axis of rotation;
at least one separation cell for containing a separation bag containing a first volume of blood or blood components, wherein said separation bag is not connected to any other source of fluid;
at least one satellite container for containing a satellite bag for receiving a separated volume of a component of said first volume of blood or blood components;
at least one pinch valve for receiving a tube fluidly connecting said separation bag and said satellite bag,
wherein said separation cell and said satellite container are located beyond the associated pinch valve with respect to the axis of rotation of said rotor.

2. The apparatus of claim 1 wherein the pinch valve is axially above the separation cell and the satellite container.

3. The apparatus of claim 1 further comprising a plurality of separation cells; a plurality of satellite cells and a plurality of pinch valves.

4. The apparatus of claim 3 further comprising a squeezing system for squeezing the separation bag within the separation cell.

5. The apparatus of claim 4 wherein the squeezing system comprises an expandable chamber in said separation cell, said expandable chamber being fluidly coupled to a hydraulic pumping station.

6. The apparatus of claim 1 further comprising a squeezing system for squeezing the separation bag within the separation cell.

7. The apparatus of claim 6 wherein the squeezing system comprises an expandable chamber in said separation cell, said expandable chamber being fluidly coupled to a hydraulic pumping station.

8. An apparatus for separating blood or blood components into at least a first component and a second component, the apparatus comprising a centrifuge having
a rotor having an axis of rotation;
at least one separation cell for containing a separation bag containing a first volume of blood or blood components, wherein said separation bag is isolated from any other source of fluid;
at least one satellite container for containing a satellite bag for receiving a separated volume of a component of said first volume of blood or blood components;
at least one associated path for receiving a tube fluidly connecting said separation bag and said satellite bag,
wherein said separation cell and said satellite container are located beyond the associated path with respect to the axis of rotation of said rotor.

9. The apparatus of claim 8 wherein the associated path for receiving said tube raises axially above the separation cell and the satellite container.

10. The apparatus of claim 8 further comprising a plurality of separation cells; a plurality of satellite cells and a plurality of paths.

11. The apparatus of claim 10 further comprising a squeezing system for squeezing the separation bag within the separation cell.

12. The apparatus of claim 11 wherein the squeezing system comprises an expandable chamber in said separation cell, said expandable chamber being fluidly coupled to a hydraulic pumping station.

13. An apparatus for separating blood or blood components into at least a first component and a second component, the apparatus comprising a centrifuge having
a rotor having an axis of rotation;
at least one separation cell for containing a separation bag containing a first volume of blood or blood components, said separation bag being connected solely to one or more satellite bags;
at least one satellite container for containing at least one satellite bag for receiving a separated volume of a component of said first volume of blood or blood components;
means for receiving a tube fluidly connecting said separation bag and said satellite bag,
wherein said means for receiving said tube is radially closer to said axis of rotation than both said separation cell and said satellite container.

14. The apparatus of claim 13 wherein the means for receiving said tube is axially above the separation cell and the satellite container.

15. The apparatus of claim 13 further comprising a plurality of separation cells; a plurality of satellite cells and a plurality of tube receiving means.

16. The apparatus of claim 15 further comprising a squeezing system for squeezing the separation bag within the separation cell.

17. The apparatus of claim 13 wherein the squeezing system comprises an expandable chamber in said separation cell, said expandable chamber being fluidly coupled to a hydraulic pumping station.

18. A method for separating blood or blood components into at least a first component and a second component, the method comprising
providing a centrifuge having a rotor having an axis of rotation;
placing a separation bag containing a first volume of blood or blood components in at least one separation cell, wherein said separation bag is not connected to any other source of blood;
placing a satellite bag for receiving a separated volume of a component of said first volume of blood or blood components in at least one satellite container;
securing a tube fluidly connecting said separation bag and said satellite bag, wherein said separation cell and said satellite container are located beyond at least a portion of said tube with respect to the axis of rotation of said rotor;
rotating said rotor;
causing air in said bags to accumulate in that portion of said tube that is closer to the axis of rotation than either said separation bag or said satellite bag; and
causing separated blood components to pass through said tube and adjacent air accumulated in said tube.

19. The method of claim 18 further comprising air in said bags to accumulate in a portion of said tube that is axially above both said separation bag and said satellite bag.

20. The method of claim 18 further comprising using a plurality of separation cells; a plurality of satellite cells and a plurality of tubes.

21. The method of claim 20 further comprising squeezing the separation bag within the separation cell.

22. The method of claim 21 wherein the squeezing step comprises expanding an expandable chamber in said separation cell, said expandable chamber being fluidly coupled to a hydraulic pumping station.

23. The method of claim 18 further comprising squeezing the separation bag within the separation cell.

24. The apparatus of claim 23 wherein the squeezing step comprises expanding an expandable chamber in said separation cell, said expandable chamber being fluidly coupled to a hydraulic pumping station.
